(19) United States
(12) Patent Application Publication
(10) Pub. No.: US 2025/0303954 A1
(43) Pub. Date: Oct. 2, 2025

(54) CONCEALMENT DEVICE FOR VEHICLE INTERIOR

(71) Applicant: Rhonda Ricardo, Newport Beach, CA (US)

(72) Inventor: Rhonda Ricardo, Newport Beach, CA (US)

(21) Appl. No.: 19/089,566

(22) Filed: Mar. 25, 2025

Related U.S. Application Data
(60) Provisional application No. 63/570,098, filed on Mar. 26, 2024.

(51) Int. Cl. B60P 7/08; B60R 5/04

(52) U.S. Cl. CPC B60P 7/0876; B60R 5/045

(57) ABSTRACT

A device for concealing items in a vehicle interior has a flexible sheet body adapted to visually blend in with an area of the vehicle interior that is being concealed. The flexible sheet body extends from a central area to a perimeter edge and may include at least one weight adjacent the perimeter edge. The entire device is soft so that it does not scratch surrounding items or surfaces, and the device is further adapted so that it does not cling to items, thereby resulting in a smooth appearance while in use, thereby concealing the item.

### CROSS-REFERENCE TO RELATED APPLICATIONS

This application for a utility patent claims the benefit of U.S. Provisional Application No. 63/570,098, filed Mar. 26, 2024.

### BACKGROUND OF THE INVENTION

### Field of the Invention

This invention relates generally to covers, and more particularly to a flexible cover that is adapted to cover items in a vehicle interior.

### Description of Related Art

The prior art teaches a wide range of covers for covering portions of a vehicle.

Southey, U.S. Pat. No. 10,315,582, for example, teaches a cover that includes traverse elongate stiffeners that are configured to hold the cover over a rear luggage compartment of a motor vehicle The cover is in the form of a substantially rectangular flexible sheet adapted to conceal items from view.

Chumoava, U.S. 2022/0144176, teaches a similar covering sheet that is also used for covering a luggage compartment of a vehicle. The covering is constructed of a textile fabric that includes first and second types of yarn, and is supported by a pair of rods at front and rear edges of the covering material.

A similar structure is also shown in Yagi, U.S. Pat. No. 4,168,094 (Assigned to Toyota), which teaches a cover sheet that is adapted to cover a trunk compartment of a vehicle. The cover sheet is mounted on a winder adapted to store the cover sheet, so that when luggage is placed on the luggage floor, the cover sheet is extended to cover up the luggage floor. See also Decker, U.S. Pat. No. 5,224,748, and Sparrer, U.S. Pat. No. 7,055,877.

Renz, U.S. Pat. No. 7,971,626, which is almost identical to Sparrer, teaches a protective device for a vehicle interior having a flexible sheetlike structure provided on opposite sides with side edge regions, a winding shaft rotatably mounted and on which the sheetlike structure is held such that it can be wound up and unwound, and dimensionally rigid pull-out profile fixedly connected to a front face end region of the sheetlike structure in the unwinding direction. Each side edge region of the sheetlike structure cooperates with at least one deflecting guide means which, in a force-fitting and/or form-fitting manner, transmits to the side edge region a tensile force component which acts outward transversely with respect to the winding-up or unwinding direction of the sheetlike structure.

Hrdlicka, U.S. 2012235451 teaches a car seat storage providing an area of space for storage of loose items within a vehicle. The car seat storage system has a bottom panel connected to two side panels and a front panel. A tuck strip is an extension of the bottom panel, and is used to secure the bottom panel to space between the seat back and the seat bottom. Additional straps and hooks are used to secure the storage system to the seat. The front panel overhangs the front edge of the seat. The front panel is a padded or reinforced panel which presses against the front of the seat edge in the event of an abrupt stopping of the vehicle. The force exerted against the front panel in response assists in maintaining the front panel in an upright position. The seat storage system is configurable to join two seat storage systems in an expanded configuration.

Thomson, U.S. 2010/0116447, teaches a sheet of pliable material that includes fasteners for fastening the sheet to a window via suction cups.

The prior art shows coverings for the interior of a vehicle. However, the prior art does not provide a covering that visually blends with the interior, and the prior art does not teach a covering that includes weights, cuffs, and fasteners for securing around covered items. The prior art also does not teach the use of materials that are soft and pliable so that no part of the invention harms the vehicle, and which does not include a rigid bar or other structure that would limit the ability of the cover to cover larger items. The prior art also does not teach the use of a material that covers large items without clinging to the items, so the presence of the items covered would not be readily apparent. The prior art does not teach the additional cushioning use of the sponge-like body pliability and material properties by using one layer or by folding or rolling the body which would increase the cushioning abilities, to place between items in vehicles to guard against scratches or other damage to items that cushioning could prevent. The present invention fulfills these needs, as well as providing other benefits, as described in the following summary.

### SUMMARY OF THE INVENTION

The present invention teaches certain benefits in construction and use which give rise to the objectives described below.

The present invention provides a device for concealing items in a vehicle interior, comprising a flexible sheet body adapted to visually blend in with an area of the vehicle interior that is being concealed. The flexible sheet body extends from a central area to a perimeter edge and could include at least one weight adjacent the perimeter edge.

A primary objective of the present invention is to provide a device for concealing items in a vehicle interior having advantages not taught by the prior art.

Another objective is to provide a device for concealing items in a vehicle interior that visually blends with the vehicle interior.

Another objective is to provide a device for concealing items that is adapted to smoothly cover the items without cling, effectively concealing said items and reducing the possibility of theft.

Another objective is to provide a device for concealing items that is soft so that it does not harm surrounding surfaces, and which does not include a rigid bar or other structure that would limit the ability of the device to cover larger items.

A further objective is to provide a device for cushioning items in a vehicle interior to help guard against scratches or damage to items or to the vehicle.

A further objective is to provide a device for concealing items in a vehicle interior that includes weights and fasteners for securing the device around concealed items.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the present invention.

FIG. 1 is an exploded perspective view of a concealment device according to one embodiment of the present invention, the concealment device being shown in a vehicle interior being used to conceal valuables.

FIG. 2 is a perspective view of the concealment device, illustrating the concealment device secured in place to cover the valuables.

FIG. 3 is a top plan view of the device.

FIG. 4 is a plan view of a second embodiment of the concealment device shown in a first, open configuration, prior to be being converted into a bag.

FIG. 5 is a plan view thereof, showing the device in a second bag configuration.

FIG. 6 is a plan view thereof, showing the device in a third bag configuration.

FIG. 7 is a plan view thereof, showing the device in a fourth bag configuration.

FIG. 8 is a plan view of a third embodiment of the concealment device.

FIG. 9 is a plan view of a fourth embodiment of the concealment device.

FIG. 10 is a plan view of a fifth embodiment of the concealment device.

FIG. 11 is a plan view of a sixth embodiment of the concealment device.

FIG. 12 is a plan view of a seventh embodiment of the concealment device.

FIG. 13 is a plan view of an eighth embodiment of the concealment device.

FIG. 14 is a perspective view thereof, illustrating the concealment device in a rolled configuration.

FIG. 15 is an exploded perspective view of a ninth embodiment of the concealment device shown in a second vehicle interior positioned to conceal large items.

FIG. 16 is a perspective view thereof, illustrating the concealment device covering the large items.

### DETAILED DESCRIPTION OF THE INVENTION

The above-described drawing figures illustrate the invention, a device for concealing items in a vehicle interior.

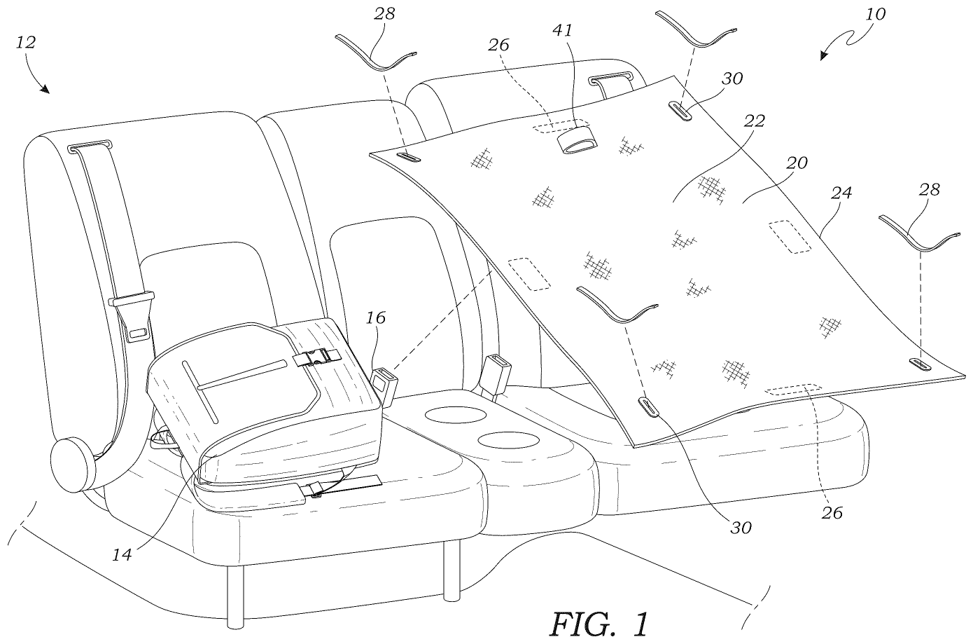

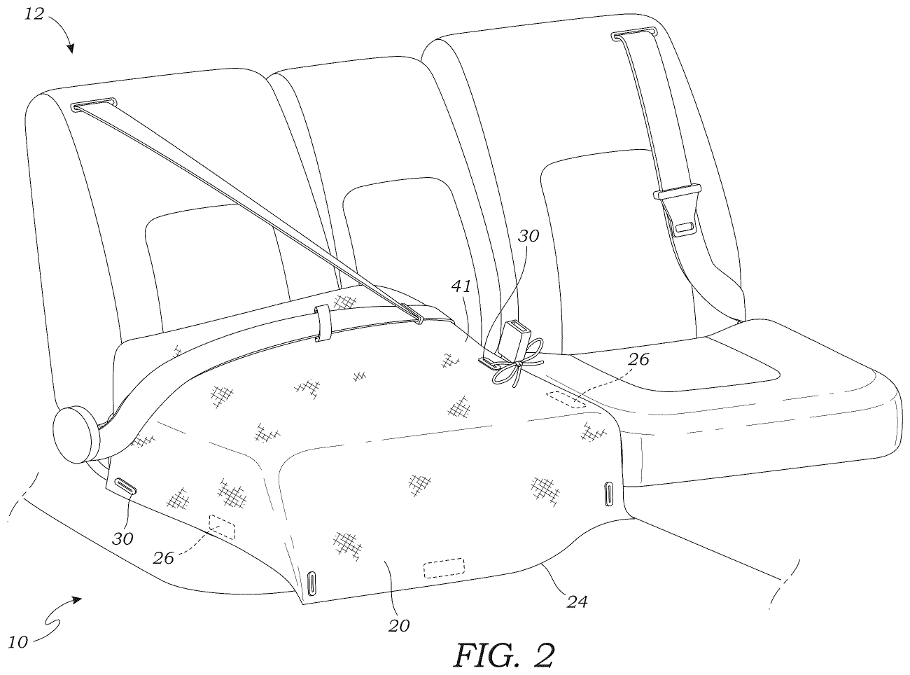

FIG. 1 is an exploded perspective view of a concealment device 10 according to one embodiment of the present invention, and FIG. 2 is a perspective view of the concealment device 10, illustrating the concealment device secured in place to cover an item 14 or items (e.g., valuables). As shown in FIGS. 1-2, the device 10 is adapted to cover valuables 14, to be secured in place, and to visually blend in with an area of the vehicle interior 12 that is being concealed, so that a person looking through a window from the outside cannot easily see that there are items within the vehicle that they can steal, and is therefore less likely to break in to steal items. The device 10 may also be useful in covering unsightly areas for a more appealing appearance. One or more items may be covered, such as shopping bags, work equipment, backpacks, tools, sports equipment, shoes, luggage, strollers, bikes, etc., but may alternatively be other personal belongings, clutter/junk, or damaged/stained areas, etc.

For the purposes of this application, the term “vehicle” is defined to include any form of vehicle, such as sedans, SUVs, trucks, vans, coupes, hatchbacks, buses, and the like, as well as motor homes/RVS, trailers, rickshaws, traincars, tractors and the like, helicopters, jets, and the like, motorboats and the like, and any other form of mobile enclosure that may benefit from the present invention as claimed.

As shown in FIGS. 1-2, the device 10 comprises a flexible sheet body 20 extending from a central area 22 to a perimeter edge 24. In various embodiments, the flexible sheet body 20 may be black in color, but alternatively may be any color that blends in with a vehicle interior. In some embodiments, the sheet body 20 is constructed of fabric material that does not cling to other fabrics or pile.

The sheet body 20 is constructed from materials that are specifically selected to blend most successfully in the interior of the vehicle while providing multiple coverage benefits. In one embodiment, the sheet body 20 may be between 80-95% polyester and 5-25% spandex. In one embodiment, the sheet body 20 is constructed of about 90% polyester and about 10% spandex. In another embodiment, the sheet body 20 is a sheet of thick (1-10 mm), black material. The fabric may be smooth and have a spongy feel with a tight knit polyester or spandex finish. Furthermore, in alternative constructions, the sheet body 20 may be formed of any textiles, animal hide, plastic, foam, leather, cloth, fabric, materials of natural fibers, elastic, materials of synthetic fibers, cut-resistant or cut-proof materials, a mixture of these, or any other suitable materials known in the art. Additionally, the perimeter edge 24 may include a frame (not shown) comprised of additional material or materials such as ribbon, thread, fabric, bias tape, lock strength or lock compatible materials, textiles and the like attached to the device 10 by a method such as, but not limited to stitching, sewing and the like.

As illustrated, a plurality of weights 26 are arranged adjacent the perimeter edge 24, for weighing down the device 10 surrounding covered items. In use, since the sheet body 20 is flexible, the weights 26 may be positioned in any desired configuration, i.e., surrounding, beneath, or atop the concealed items, or a mixture of these configurations. In this embodiment, the weights 26 are integrated inside the sheet body 20, are resilient in construction, and have softened edges. However, the weights 26 may alternatively be attached to the outside of the sheet body 20, or it may be detachable. In one example, the weights 26 are formed of layers of the same material as the sheet body 20. Alternatively, the weights 26 may be formed of any desired materials suitable for the purposes of this invention. In this embodiment of FIGS. 1-2, there are four weights 26, but in other embodiments, a greater or fewer number of weights may be included, or in different locations on the sheet body 20, some non-limiting examples of which being shown in the following figures. In some embodiments (not shown), there are no weights.

In one embodiment, each of the weights 26 is about 2 inches by 4 inches, and includes three layers of the sheet body, all sewn together into a single unit.

In various embodiments, the device 10 may further include fasteners 28 for fastening at least one of the perimeter edges 24 of the sheet body 20 to a portion of the vehicle interior 12. In this embodiment, the fasteners 28 are in the form of elongate flexible straps adapted to engage openings 30 adjacent the perimeter edge 24 of the flexible sheet body 20. In this embodiment, the fasteners 28 are in the form of ties removably attached to the sheet body 20, although in other embodiments, they may be sewn to or otherwise attached to the sheet body 20. In yet other embodiments, the fasteners 28 may be any other form of fastener, including but not limited to clips, clamps, locks, buttons, hook-and-loop fasteners, buckles, magnets, latches, etc., a mixture of these, or any other form of fastener compatible with the device 10 as-claimed.

The openings 30 may be reinforced with thread, keeping consistent with the discreet appearance of the device 10, and the soft components. However, in other embodiments, it may not include reinforcements. The openings 30 may also be reinforced with various types of grommets, in a preferable embodiment being of a soft material (i.e., yarn, cloth fibers, strength infused, rubber, plastic, cut-resistant or cut-proof, etc.), but any form of grommet or other reinforcement may be included (e.g., sewing). In some embodiments, the perimeter edge 24 of the device 10 may extend different lengths beyond the openings 30, for different coverage options after anchoring the flexible sheet to the desired portion(s) of the vehicle interior 12.

As shown in FIGS. 1-2, in some embodiments, the sheet body 20 further includes a cuff 41 or hole (not shown) adapted to receive a seatbelt or buckle 16, for additionally securing and anchoring the device 10 within the vehicle interior 12. The cuff 41 may be constructed with additional embodiments such as a leash, extender, etc. The seatbelt or buckle 16 may be inserted through the cuff 41 or hole (not shown) and then buckled to keep it in place. The cuff 41 or hole (not shown) may be located in any suitable position on the sheet body 20, and is not restricted to the illustrated examples. The hole (not shown) may include a reinforcement around the hole opening. In some uses, the hole may assist with changing the device 10 into a bag configuration, best shown in FIG. 9 and discussed below. Alternatively, the cuff 41 and/or hole may be excluded or removable.

With respect to the associated method, the following core steps are followed: unfold or unroll the sheet body 20 then expand the body over the vehicle interior 12 “cabin”, herein after “cab,” area and items that need to be covered by allowing the weights 26 to anchor the device edges 24 around the covered objects or area, noting the weights 26 are a weight as to not pull the device 10 away from desired position, and the weights 26 are unobtrusively comfortable to use and store along with the device 10. In some uses, the weights 26 may assist with “throwing” the sheet body 20, so that it travels in the intended direction rather than being diverted by air resistance. The weights 26 may be simply pushed or tucked to surround the covered area or item, to help stabilize the desired placement and achieve a clean look. Then the cuff 41 may be slipped over the seatbelt strap, and the seatbelt may be locked to further secure the device 10 in place. The corners of the device 10 may be anchored by utilizing the tiedowns with the corner openings 30. The device 10 can be tied to the vehicle, tied to items under the device 10, tied to an adjacent device opening, or tied anywhere that is best for covering the items. As previously mentioned, in the case of alternative forms of fasteners, the device 10 may be fastened via a different means other than tying. After use, the device 10 can be retracted to a storage position or rolled-up, or partially rolled up, to be placed between seats to use as a crumb catcher, depending on the vehicle, discussed further below.

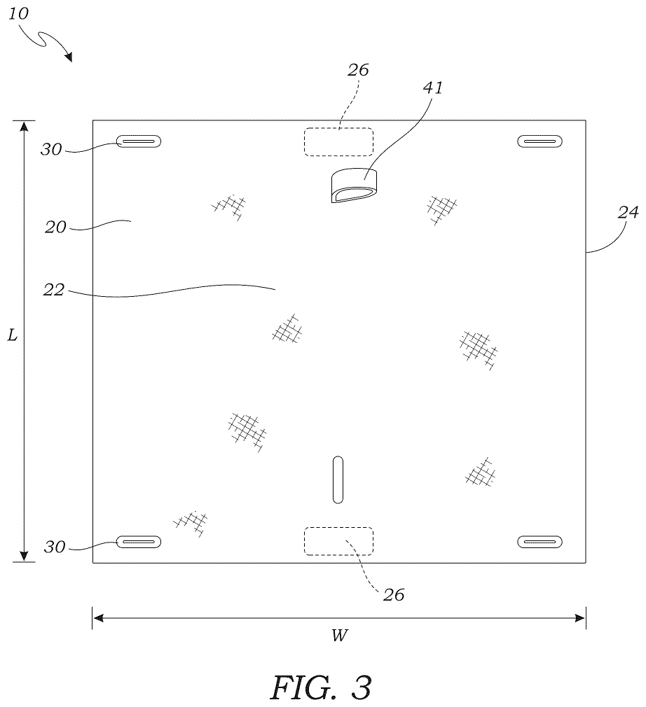

FIG. 3 is a top plan view of a second embodiment 33 of the device 10. As shown in FIG. 3, in some embodiments, the weights 26 may be arranged only at a top and bottom of the sheet body 20. FIG. 3 also illustrates a cuff 41 adjacent the perimeter edge 24, in this embodiment being in the form of a loop mounted on the fabric body 20. The cuff 41 is further shown in the following figures and discussed below.

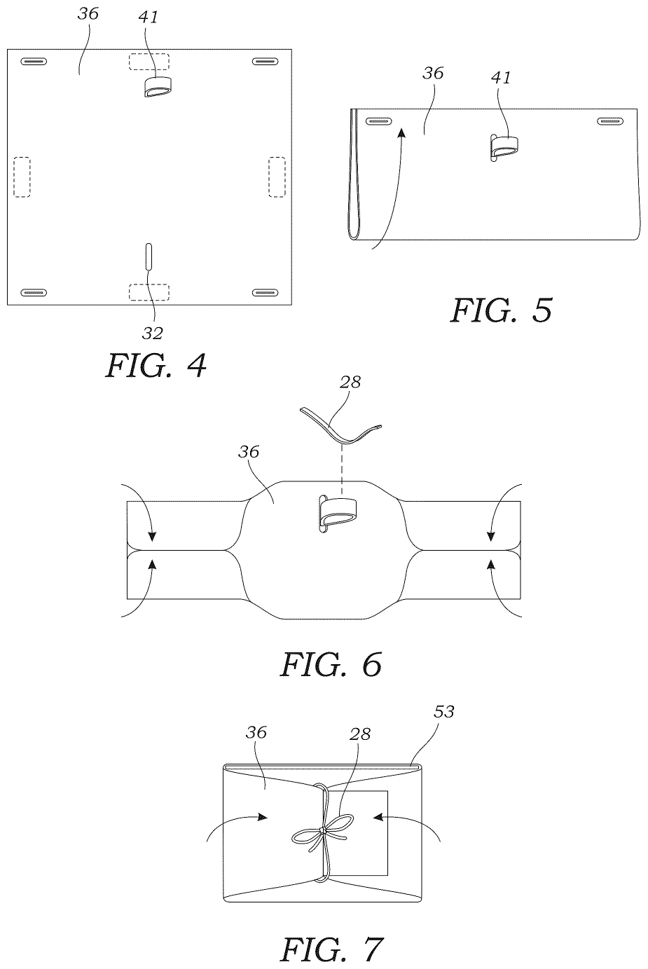

FIG. 4 is a plan view of a second embodiment 36 of the device shown in a first, open configuration. As shown in FIGS. 1-4, the sheet body 20 may be a generally rectangular shape having a width W and a length L, as shown in FIG. 3, but in other embodiments, the sheet body 20 may be any desired shape and proportions, some examples being shown in FIGS. 5-13 and discussed below. In some exemplary embodiments, W may be about 29″ and L is about 33″ (small), while in another embodiment they may be about 29×52″ (medium) or about 52×60″ (large). While these measurements are preferred because they match the typical size of interiors that are desired to be covered, obviously, other measurements may be implemented, according to the desires of the consumer.

In the embodiment of FIG. 4, the sheet body 20 includes the cuff 41 attached (i.e., sewn) to the sheet body 20 adjacent the perimeter edge and opposite the hole 32. FIG. 5 is a plan view thereof, showing the device in a second configuration. As shown in FIG. 5, in this embodiment, the device 36 may be converted into a bag configuration by first folding the sheet body 20 in half so that the cuff 41 passes through the hole 32. FIG. 6 illustrates a next step of the conversion, showing the perimeter edge on either side of the cuff/hole being folded as-shown. A tiedown 28 may further pass through the cuff 41 that is positioned through the hole 32. FIG. 7 illustrates a final, bag configuration that is achieved by folding the folded sides on top of the cuff, wherein the tiedown 28 can tie the sides together. In the configuration of FIG. 7, an opening 53 is created on the top of the device 36 suitable for use as a bag.

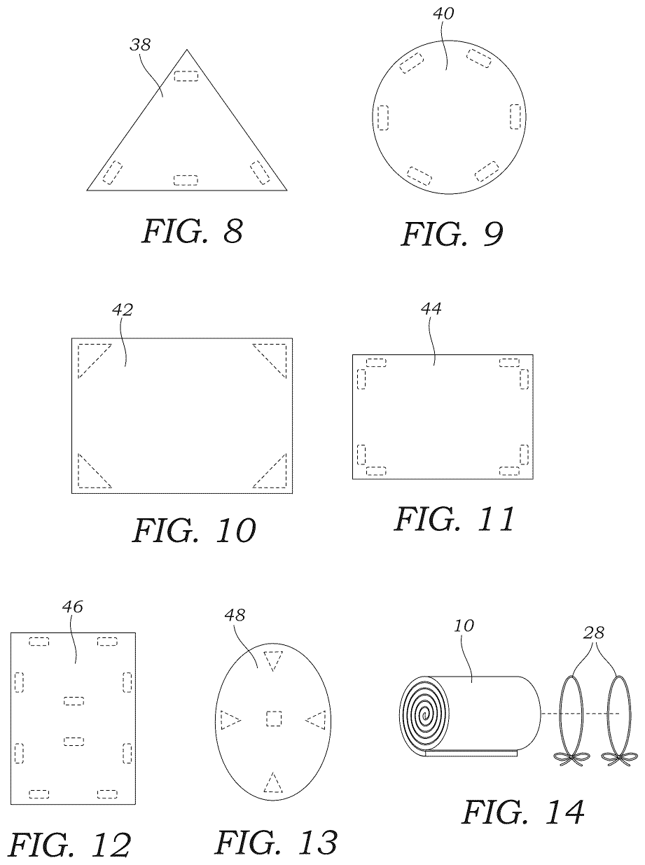

FIG. 8 is a plan view of a third embodiment 38 of the device, illustrating the device 38 in a generally triangular shape. FIG. 9 is a plan view of a fourth embodiment of the device 40, illustrating the device 40 in a generally circular shape.

FIG. 10 is a plan view of a fifth embodiment 42 of the device, illustrating the device 42 in a generally rectangular shape and having the weights in a generally triangular shape and positioned adjacent corners of the sheet body 20, rather than the generally rectangular weights adjacent the side edges shown in the previous embodiments.

FIG. 11 is a plan view of a sixth embodiment 44 of the device, showing another potential configuration of the weights.

FIG. 12 is a plan view of a seventh embodiment 46 of the device, showing the weights in yet another configuration. FIG. 13 is a plan view of an eighth embodiment 48 of the device, showing the perimeter edge 24 of the device 48 in a generally ovular shape, with a mixture of generally rectangular and triangular weights.

While the various embodiments each show different feature combinations, it should be understood that the openings 30/32, cuff 41, hole 32, or any other features may be applied to any of the embodiments, in various configurations, and the scope of the claims encompasses any combination of features shown in the drawings, as well as other potential configurations.

FIG. 14 is a perspective view of the device 10 of FIGS. 1-4, illustrated in a rolled configuration. However, any of the illustrated embodiments, and further not-illustrated embodiments, may be rolled to the same effect. The device 10 can be retracted to a storage position, or, as shown in FIG. 14, rolled up and secured with the fasteners. In the rolled configuration, the device 10 may be placed between seats or other gaps in the vehicle interior 12 to use as a crumb catcher or liner, depending on the vehicle. The method to use and store the device 10 in gaps between seats, console, etc. may shield against food crumbs and other items that can become lost in seat gaps or under the seats if the seat gaps are not filled. This configuration may also be utilized to store the device 10 because the device 10 blends with the vehicle interior 12. Alternatively, the device 10 can be folded, secured in place with the attachment apparatus (tiedowns 28) and/or the cuff 41, then stored wherever convenient. Vehicles can use more than one device 10 at a time depending on the need. As should be clear from the drawings and present disclosure, the device 10 may be made in different sizes and shapes for different size vehicles and different needs.

Another use includes covering personal property while continuing to use the body of the device 10 to shield foreign objects from between seats, floors, vehicle pockets, or wherever convenient, i.e., parts of the sheet body 20 are spread across, rolled, or folded into gaps in the vehicle. It should be further noted that the fasteners may be affixed permanently or completely separated from the sheet body 20 to be used later when affixing or storing the device 10.

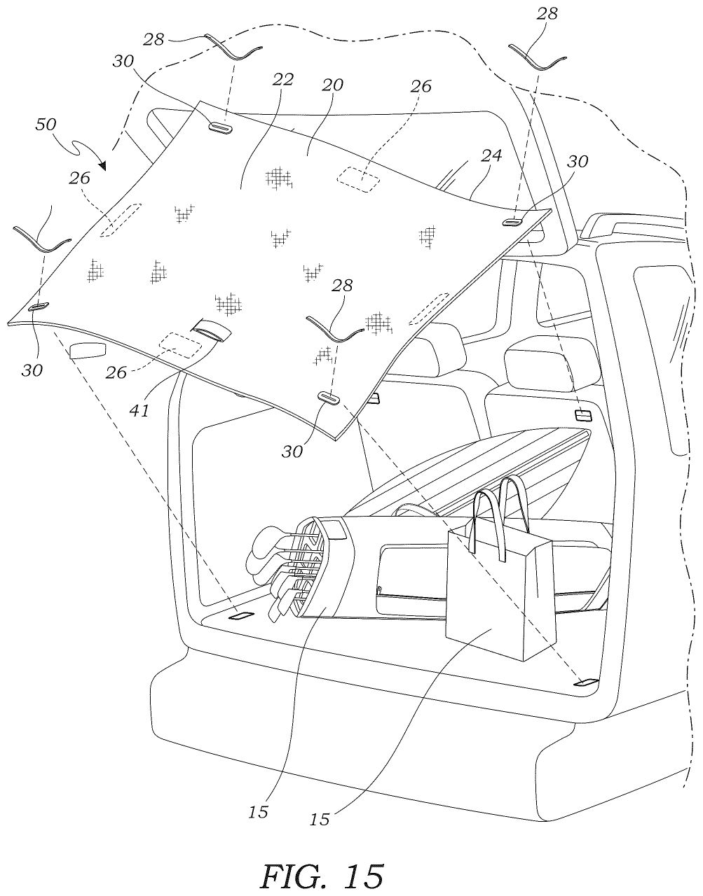

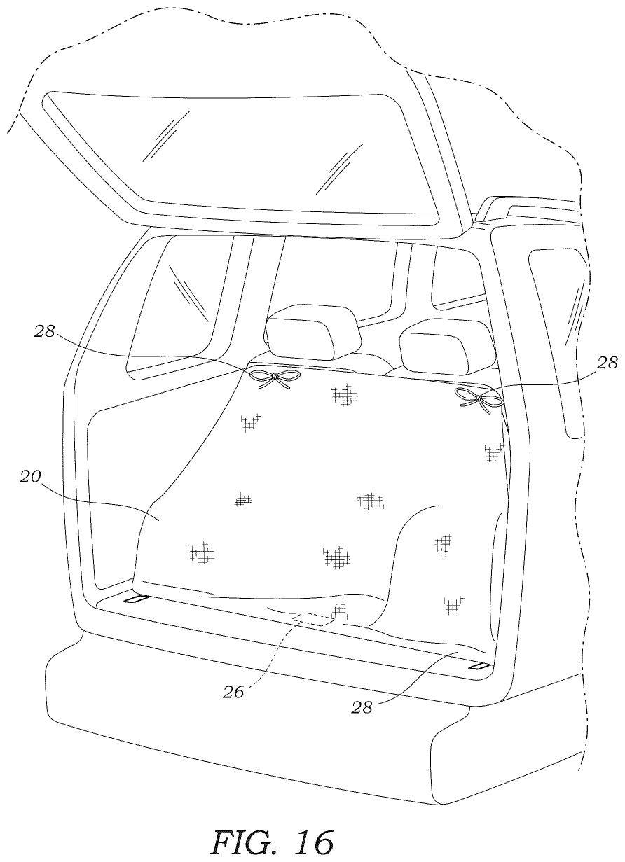

FIG. 15 is an exploded perspective view of a ninth embodiment 50 of the concealment device shown in a second vehicle interior being used to conceal large items 15, and FIG. 16 is a perspective view thereof, illustrating the concealment device 50 secured in place to cover the items 15. As shown in FIGS. 15-16, the device 50 may be sized large enough to cover larger items 15, such as the golf bag, surfboard, and shopping bag illustrated, and may be secured/tied to the items or the vehicle and stabilized by the attached soft weights 26, but as discussed, any items that fit in the vehicle interior may be covered by one or more concealment device(s). As illustrated, the large items 15 may be just as seamlessly covered as the smaller items 14 of FIGS. 1-2. The fabric body 20 is designed to smoothly cover items without clinging or catching, to create a smooth final appearance (FIG. 16).

As shown in FIGS. 15-16, the tiedowns 28 may be attached to existing structures in a vehicle storage area, with many possible configurations and attachment points, depending on the items being covered, and user preference.

In some embodiments (not shown), the device 10 (or the device 36, 38, 40, 42, 44, 46, 48, 50, or further not-illustrated embodiments) may include various accessories to enhance use of the device like, pouches, cases, pockets, hangers, drawstrings, etc., which should be considered within the scope of the present invention.

The title of the present application, and the claims presented, do not limit what may be claimed in the future, based upon and supported by the present application. Furthermore, any features shown in any of the drawings may be combined with any features from any other drawings to form an invention which may be claimed.

As used in this application, the words “a,” “an,” and “one” are defined to include one or more of the referenced item unless specifically stated otherwise. The terms “approximately” and “about” are defined to mean +/−10%, unless otherwise stated. Also, the terms “have,” “include,” “contain,” and similar terms are defined to mean “comprising” unless specifically stated otherwise. Furthermore, the terminology used in the specification provided above is hereby defined to include similar and/or equivalent terms, and/or alternative embodiments that would be considered obvious to one skilled in the art given the teachings of the present patent application. While the invention has been described with reference to at least one particular embodiment, it is to be clearly understood that the invention is not limited to these embodiments, but rather the scope of the invention is defined by claims made to the invention.

What is claimed is:

1. A device for concealing an item in a vehicle interior, comprising:
a flexible sheet body that extends from a central area to a perimeter edge, the sheet body being adapted to visually blend in with an area of the vehicle interior that is being concealed.

2. The device of claim 1, wherein the sheet body further includes fasteners for fastening at least the perimeter edge to a portion of the vehicle interior.

3. The device of claim 2, wherein the fasteners are elongate flexible straps adapted to engage openings adjacent the perimeter edge of the flexible sheet body.

4. The device of claim 3, wherein the openings are reinforced with thread or grommets.

5. The device of claim 1, further comprising at least one weight adjacent the perimeter edge.

6. The device of claim 1, further comprising a plurality of weights that are integrally formed with the sheet body.

7. The device of claim 1, wherein the weights are constructed of a plurality of layers of the material from which the sheet body is formed.

8. The device of claim 1, wherein the sheet body is constructed of polyester and spandex.

9. The device of claim 1, wherein the sheet body is constructed of fabric material that does not cling to other fabrics or items.

10. The device of claim 1, wherein the sheet body is constructed of 80-95% polyester and 5-20% spandex.

11. The device of claim 1, wherein the sheet body is 25-45″ in width and 45-85″ in length.

12. The device of claim 1, wherein the sheet body includes a cuff adapted to receive a seatbelt or buckle, for additionally securing and anchoring the device within the vehicle interior.

13. The device of claim 1, wherein the flexible sheet body is adapted to be converted into a storage bag and secured with the fasteners.

14. The device of claim 1, wherein the flexible sheet body does not include a rod or other hard and rigid structure that would impair the ability of the flexible sheet body to drape over the item.

15. A method for concealing at least one item within a vehicle interior, the method comprising the steps of:
providing a concealment device comprising a flexible sheet body that extends from a central area to a perimeter edge, the sheet body being black and adapted to visually blend in with an area of the vehicle interior, and being constructed of a material that does not cling or closely conform to items beneath the flexible sheet body; and
spreading the sheet body within the vehicle interior and over the at least one item to be concealed.

16. The method of claim 15, wherein the concealment device further includes a plurality of weights adjacent the perimeter edge, and wherein the method further comprises the step of positioning the weights around the item.

17. The method of claim 15, wherein the concealment device further includes at least one fastener or opening for a removable fastener adjacent the perimeter edge, and wherein the method further comprises the step of fastening the concealment device around the item.

18. A method for concealing at least one item within a vehicle interior, the method comprising the steps of:
providing a concealment device comprising:
a flexible sheet body that extends from a central area to a perimeter edge, the sheet body being adapted to visually blend in with an area of the vehicle interior;
a plurality of weights formed or attached adjacent the perimeter edge; and
fasteners for fastening at least the perimeter edge to anchoring areas of the vehicle interior;
a cuff adapted to receive a seatbelt or buckle;
spreading the sheet body within the vehicle interior and over the at least one item to be concealed;
feeding the seatbelt or buckle through the cuff and buckling the seatbelt to the buckle;
positioning the weights around the item; and
fastening the fasteners to the anchoring areas.
